(19) United States
(12) Patent Application Publication
(10) Pub. No.: US 2011/0279695 A1
(43) Pub. Date: Nov. 17, 2011

(54) IMAGING APPARATUS

(75) Inventors: KEN ISHIDA, Osaka (JP); SENICHI ONODA, Osaka (JP); JUN TAKEMURA, Osaka (JP)

(73) Assignee: PANASONIC CORPORATION, Osaka (JP)

(21) Appl. No.: 13/049,076

(22) Filed: Mar. 16, 2011

(30) Foreign Application Priority Data
Mar. 18, 2010 (JP) 2010-062328

(51) Int. Cl. H04N 5/225

(52) U.S. Cl. 348/220.1; 348/E05.024

(57) ABSTRACT

An imaging apparatus includes an imaging unit configured to capture a subject image to generate image data, an instruction receiving unit configured to receive an instruction for shooting a still image, a moving image recorder configured to record, as moving image data, the image data in a recording medium, and a still image information recorder configured to record information about still image shooting in a nonvolatile recording medium when the instruction receiving unit receives the instruction for shooting the still image during recording of the moving image data.

### BACKGROUND

1. Technical Field

The technical field relates to an imaging apparatus, and more particularly to an imaging apparatus capable of performing still image shooting during moving image recording.

2. Related Art

Imaging apparatuses such as digital cameras that can extract still image data from a moving image and record the still image data during moving image recording have been disseminated. For example, JP9-154104A discloses an imaging apparatus that temporarily holds still image data in an internal memory in response to an instruction for shooting a still image provided during moving image recording, records moving image data in a recording medium, and thereafter reads the still image data in the internal memory and records the still image data in the recording medium.

Such a conventional imaging apparatus has a problem that, when the power interruption occurs during moving image recording, still image data recorded in the internal memory disappears. Specifically, when the power interruption occurs during moving image recording, data in the internal memory disappears. Thus, if still images recorded in the internal memory are not yet recorded in the recording medium before power interruption, then even when the power is restored after the power interruption, it is difficult to recover still image data.

To solve the above-described problem, an imaging apparatus is provided that is capable of preventing, even if power interruption occurs during moving image recording, loss of data of still images for which shooting instructions are provided during the moving image recording.

### SUMMARY

In a first aspect, an imaging apparatus capable of recording moving image data and still image data is provided. The imaging apparatus includes an imaging unit configured to capture a subject image to generate image data; an instruction receiving unit configured to receive an instruction for shooting a still image; a moving image recorder configured to record, as moving image data, the image data in a predetermined recording medium; and a still image information recorder configured to record information about still image shooting in a nonvolatile recording medium when the instruction receiving unit receives the instruction for shooting a still image during recording of the moving image data.

In a second aspect, a method of generating still image data from moving image data recorded in a predetermined recording medium is provided. According to the generation method, information about shooting of a still image for which a shooting instruction is provided during recording of the moving image data is obtained; a moving image frame in the moving image data is identified based on the obtained information about shooting of a still image; and still image data is generated based on the identified moving image frame.

In a third aspect, a non-transitory computer-readable recording medium having a program is provided. The program causes a computer to perform: a function of obtaining information about shooting of a still image for which a shooting instruction is provided during recording of moving image data; a function of identifying a moving image frame in the moving image data based on the obtained information about shooting of a still image; and a function of generating still image data based on the identified moving image frame.

In a fourth aspect, a method of recovering still image data is provided. In the recovery method, when an instruction for shooting a still image is received during recording of moving image data, information about still image shooting is recorded in a nonvolatile recording medium; and still image data is generated from the moving image data based on the information about still image shooting recorded in the nonvolatile recording medium.

According to the aspects, information about still image shooting recorded during moving image recording (for example, information identifying a moving image frame) is recorded in a nonvolatile recording medium. By this configuration, even if power interruption occurs during moving image recording, by referring to information about still image shooting (for example, information identifying a moving image frame) when the power is restored after the power interruption, a moving image frame in which an instruction for shooting a still image is provided can be identified from among moving image data, and still image data can be generated from the identified moving image frame. By this, loss of still image data caused by power interruption during data recording can be prevented, enabling to improve user convenience.

### BRIEF DESCRIPTION OF DRAWINGS

FIG. 1 is a front view of a digital camera according to a first embodiment.

FIG. 2 is a back view of the digital camera according to the first embodiment.

FIG. 3 is a block configuration diagram of the digital camera according to the first embodiment.

FIG. 4 is a configuration diagram for describing an intermediate file storage directory created upon still image shooting during moving image recording.

FIG. 5 is a diagram describing a format of an intermediate file created upon still image shooting during moving image recording.

FIG. 6 is a diagram showing a structure of a header section of the intermediate file.

FIG. 7 is a diagram showing a structure of a still image data section of the intermediate file.

FIG. 8 is a diagram showing a structure of still image information included in the still image data section of the intermediate file.

FIG. 9 is a flowchart showing a moving image and still image recording process in shooting mode performed by the digital camera.

FIG. 10 is a flowchart showing a process of creating still images to be recorded.

FIG. 11 is a flowchart showing a still image recovery process.

FIG. 12 is a flowchart showing specific procedural steps of a process of recovering still images from a moving image file.

### DETAILED DESCRIPTION OF PREFERRED EMBODIMENT

A preferred embodiment will be described below with reference to the accompanying drawings.

### First Embodiment

A digital camera according to a first embodiment is an imaging apparatus capable of performing still image shooting during moving image recording. When performing still image shooting during moving image recording, the digital camera according to the first embodiment records, as an intermediate file, information on instructions for shooting still images provided by a user in a recording medium such as a memory, and records, based on the information, still images according to the shooting instructions provided during the moving image recording. Details of the configuration and operation of such a digital camera will be described below.

### 1. Configuration

1-1. Configuration of Digital Camera

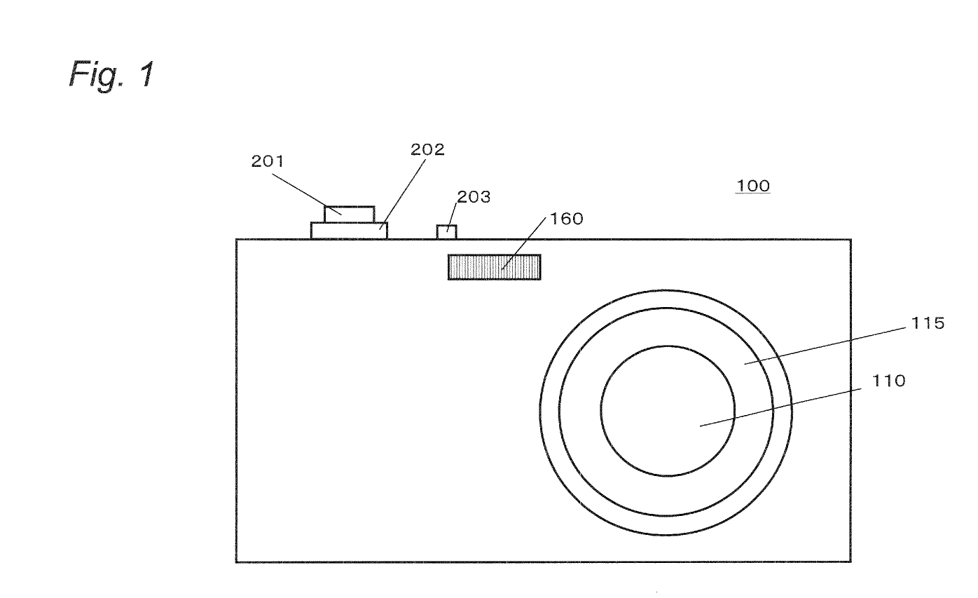

FIG. 1 is a front view of a digital camera according to the first embodiment. A digital camera 100 includes, at the front thereof, a lens barrel 115 that contains an optical system 110, and a flash 160. In addition, the digital camera 100 includes, at the top thereof, operating buttons such as a still image release button 201, a zoom lever 202, and a power button 203.

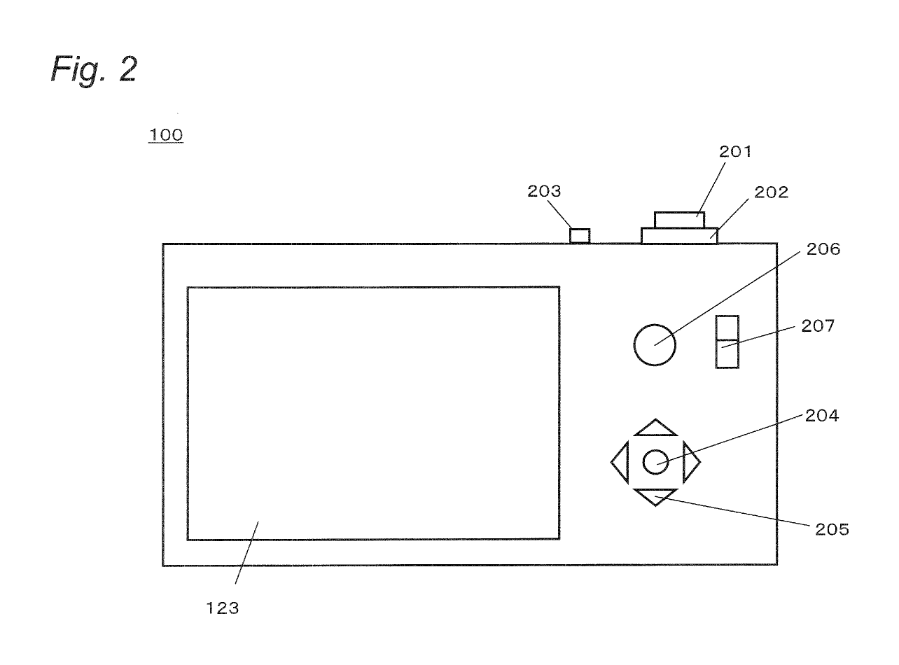

FIG. 2 is a back view of the digital camera 100. The digital camera 100 includes, at the back thereof, a liquid crystal display (LCD) monitor 123 and operating buttons such as a central button 204, cursor buttons 205, a moving image release button 206, and a mode switch 207.

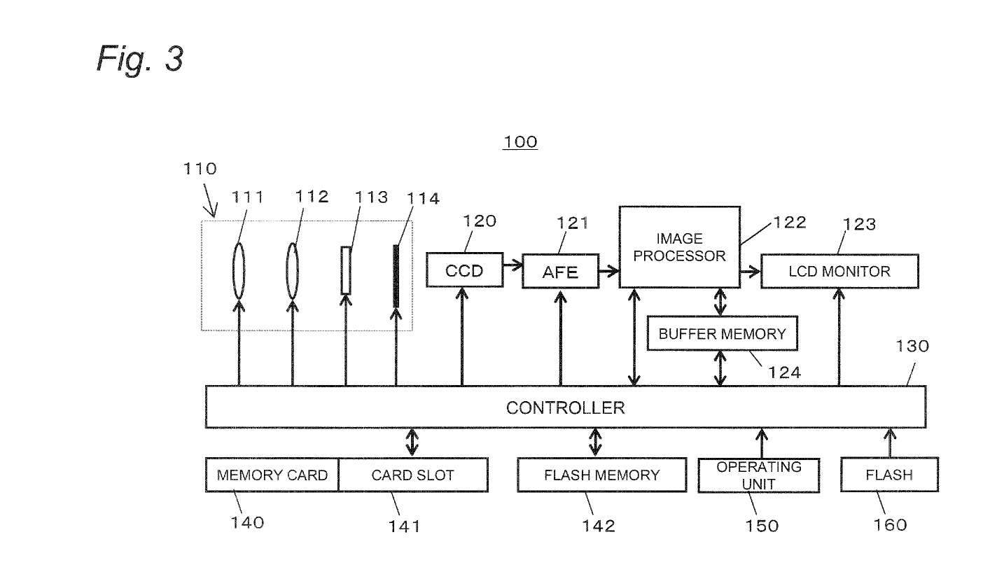

FIG. 3 is a block diagram of the digital camera 100. The digital camera 100 includes a CCD image sensor 120 that captures a subject image formed through the optical system 110. The CCD image sensor 120 generates image information based on the captured subject image. The image information generated by capturing is subjected to various processes in an AFE (Analog Front End) 121 and an image processor 122. The generated image information is recorded in a nonvolatile recording medium such as a flash memory 142 or a memory card 140. The image information recorded in the flash memory 142 or the memory card 140 can be displayed (played back) on the liquid crystal display monitor 123, according to an operation performed on an operating unit 150 by a user. Details of the components shown in FIGS. 1 to 3 will be described below.

The optical system 110 includes a focus lens 111, a zoom lens 112, a diaphragm 113, a shutter 114 and the like. Though not shown, the optical system 110 may include an optical camera shake correction lens, OIS (Optical Image Stabilizer). Note that each lens included in the optical system 110 may be of any number and may be of any group.

The focus lens 111 is used to adjust the focus state of a subject. The zoom lens 112 is used to adjust the angle of view of a subject. The diaphragm 113 is used to adjust the amount of light entering the CCD image sensor 120. The shutter 114 adjusts the exposure time of light entering the CCD image sensor 120. The focus lens 111, the zoom lens 112, the diaphragm 113, and the shutter 114 are driven by their respective drivers such as DC motors or stepping motors, according to control signals provided from a controller 130.

The CCD image sensor 120 captures a subject image formed through the optical system 110 and thereby generates image information. The CCD image sensor 120 can generate image information for a new frame every certain period of time when the digital camera 100 is in shooting mode.

The AFE 121 performs noise suppression by correlated double sampling, amplification of the input range width of an A/D converter by an analog gain controller, and A/D conversion by an A/D converter, on the image information read from the CCD image sensor 120. Thereafter, the AFE 121 outputs the image information to the image processor 122.

The image processor 122 performs various processes on the image information outputted from the AFE 121. The various processes include, for example, smear correction, white balance correction, gamma correction, a YC conversion process, an electronic zoom process, a compression process, and a decompression process, but are not limited thereto. The image processor 122 stores the image information having been subjected to various processes, in a buffer memory 124. The image processor 122 may be composed of a hard-wired electronic circuit or may be composed of a microcomputer using a program and the like. The image processor 122 may be composed of a single semiconductor chip, together with other circuits such as the controller 130.

The liquid crystal display monitor 123 is provided on the back of the digital camera 100. The liquid crystal display monitor 123 displays an image created based on the image information processed by the image processor 122. Images displayed on the liquid crystal display monitor 123 include through images and recorded images. A through image is an image such that images for new frames which are created every certain period of time by the CCD image sensor 120 are continuously displayed. In normal times, when the digital camera 100 is in shooting mode, the image processor 122 creates a through image from image information generated by the CCD image sensor 120. The user can perform shooting while checking the composition of a subject by seeing a through image displayed on the liquid crystal display monitor 123. A recorded image is an image obtained by downscaling a high-pixel image recorded in the memory card 140 and the like, to a low-pixel one to display the image on the liquid crystal display monitor 123, when the digital camera 100 is in playback mode. High-pixel image information recorded in the memory card 140 is generated by the image processor 122 based on image information generated by the COD image sensor 120, after receiving an operation of the still image release button 201 by the user.

The controller 130 performs overall control of the entire operation of the digital camera 100. In addition, the controller 130 records image information processed by the image processor 122 and stored in the buffer memory 124, in a recording medium such as the memory card 140. The controller 130 includes a ROM that stores information such as programs, a CPU that processes various information by executing programs and the like. The ROM stores a program for performing overall control of the entire operation of the digital camera 100, in addition to programs relating to file control, autofocus control control), automatic exposure control (AE control), light emission control of the flash 160.

The controller 130 may be composed of a hard-wired electronic circuit or may be composed of a microcomputer and the like. Alternatively, the controller 130 may be composed of a single semiconductor chip, together with the image processor 122 and the like. The ROM does not need to be an internal component of the controller 130 and may be provided outside the controller 130.

The buffer memory 124 is a storage unit that functions as a working memory for the image processor 122 and the controller 130. The buffer memory 124 can be implemented by a DRAM (Dynamic Random Access Memory) and the like. The flash memory 142 functions as an internal memory for recording image information and the like.

A card slot 141 is a connector into which the memory card 140 can be inserted. The card slot 141 can be connected to the memory card 140 electrically and mechanically. The card slot 141 may have the function of controlling the memory card 140.

The memory card 140 is an external memory including internally a recording device such as a flash memory. The memory card 140 can record data such as image information processed by the image processor 122.

The operating unit 150 is a collective term for operating buttons and an operating dial provided on the exterior of the digital camera 100, and accepts operations performed by the user. The operating unit 150 corresponds to, for example, the still image release button 201, the moving image release button 206, the zoom lever 202, the power button 203, the central button 204, the cursor buttons 205, and the mode switch 207 shown in FIGS. 1 and 2. When the operating unit 150 accepts an operation performed by the user, the operating unit 150 sends, to the controller 130, an operation instruction signal according to the operation.

The still image release button 201 is a button that can take press states in two steps, a half-press state and a full-press state. When the still image release button 201 is half-pressed by the user, the controller 130 performs AF (Auto Focus) control and AE (Auto Exposure) control to determine shooting conditions. Subsequently, when the still image release button 201 is full-pressed by the user, the controller 130 records, as a still image, image information captured at the timing of the full-press in the memory card 140 and the like. In the following, unless otherwise specifically stated, “press the still image release button 201” means a full-press of the still image release button 201.

The moving image release button 206 is a press type button for instructing the start/end of moving image recording. When the moving image release button 206 is pressed by the user, the controller 130 sequentially records, as a moving image, image information generated by the image processor 122 based on image information generated by the CCD image sensor 120, in a recording medium such as the memory card 140. When the moving image release button 206 is pressed again, the moving image recording ends.

The zoom lever 202 is a central position self-returning type lever for adjusting the angle of view between a wide-angle end and a telephoto end. When the zoom lever 202 is operated by the user, the zoom lever 202 sends an operation instruction signal for driving the zoom lens 112, to the controller 130. Specifically, when the zoom lever 202 is operated to the wide-angle end side, the controller 130 drives the zoom lens 112 such that a subject can be captured at a wide angle. Likewise, when the zoom lever 202 is operated to the telephoto end side, the controller 130 drives the zoom lens 112 such that a subject can be captured in a telephoto way.

The power button 203 is a press type button for turning on/off the power supply to the units included in the digital camera 100. When the power button 203 is pressed by the user at power-off, the controller 130 supplies power to the units included in the digital camera 100 to activate them. When the power button 203 is pressed by the user at power-on, the controller 130 stops the power supply to the units.

The central button 204 is a press type button. When the central button 204 is pressed by the user when the digital camera 100 is in shooting mode or playback mode, the controller 130 displays a menu screen on the liquid crystal display monitor 123. The menu screen is a screen for setting various conditions for shooting/playback. When the central button 204 is pressed when a setting item for various conditions is being selected, the central button 204 also functions as a set button.

The cursor buttons 205 are press type buttons provided in up, down, left, and right directions. The user can select various condition items displayed on the liquid crystal display monitor 123 by pressing any of the cursor buttons 205 provided in those directions.

The mode switch 207 is a press type button provided in an up-and-down direction. The user can switch the state of the digital camera 100 between shooting mode and playback mode by pressing the mode switch 207 in either direction.

Note that the CCD image sensor 120 is an example of an imaging unit. The controller 130 is an example of a moving image recorder. The controller 130 is an example of a still image shooting information recorder. The controller 130 is an example of a controller.

### 2. Operation

The still image or moving image recording operation of the digital camera 100 according to the first embodiment will be described below.

2-1 Directory Structure of Recording Medium

Before describing the recording operation of the digital camera 100, a directory that stores an intermediate file created upon still image shooting during moving image recording will be described. An intermediate file is a file created when there is an instruction for shooting a still image during moving image recording, and holds information about the instruction for shooting the still image.

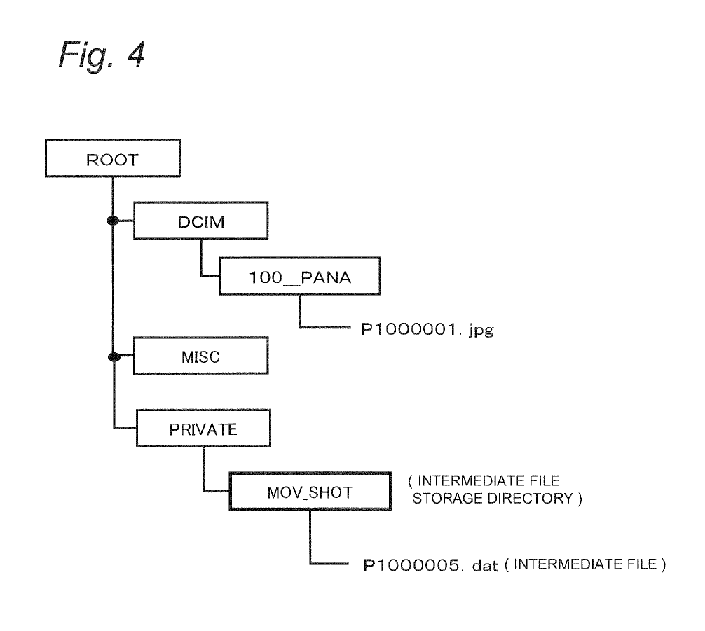

FIG. 4 is a diagram showing a directory structure created in a recording medium such as the memory card 140 in which moving image files and still image files are recorded. A character string enclosed in a box indicates a directory name and a character string that is not enclosed in a box indicates a file name.

A ROOT directory is the topmost directory in a directory structure created in a recording medium such as the memory card 140. Creation of directories and recording of still image files, moving image files, and other files are performed from a ROOT directory hierarchy level.

A DCIM directory is a directory defined by the DCF (Design rule for Camera File system) standard. The DCIM directory is created one level below the ROOT directory. A 100_PANA directory is an image directory for storing still image files and moving image files and is created one level below the DCIM directory. According to the DCF standard, it is defined that the directory name of this directory includes a 3-digit number from 100 to 999 and five free characters. FIG. 4 shows an example in which “100” is used as a 3-digit number and “_PANA” is used as five free characters. P1000001.jpg recorded one level below 100_PANA is a still image file. It is defined by the DCF standard that the file names of still image files and moving image files include four free characters and a 4-digit number from 0001 to 9999. The combination of four free characters and a 4-digit number is called a “DCF object number”. FIG. 4 shows an example in which “P100” is used as four free characters and “0001” is used as a 4-digit number. Note that in the present embodiment a still image file is in JPEG format and is provided with “jpg” as its extension. A moving image file is in Motion JPEG format and is provided with “mov” as its extension.

FIG. 4 shows a state in which only one still image file with the file name P1000001.jpg is recorded one level below 100_PANA. When still image shooting is performed next, a still image file with the file name P1000002.jpg is recorded one level below 100_PANA. Thereafter, still image files with the file names P1000003.jpg, P1000004.jpg, . . . , are recorded in chronological order.

Note that, when the number of still image files recorded one level below 100_PANA reaches 9999, 101_PANA which is a new image directory for recording still image files is created one level below the DCIM directory. In addition, even if the number of still image (or moving image) files recorded one level below 100_PANA does not reach 9999, 101_PANA which is a new image directory for recording still image files can be created one level below the DCIM directory.

One level below 101_PANA, first, a still image file with the file name P1010001.jpg is recorded and thereafter still image files with the file names P1010002.jpg, P1010003.jpg, . . . , are recorded in chronological order. As is the case with 100_PANA, when the number of still image files recorded one level below 101_PANA reaches 9999, 102_PANA which is a new image directory for recording still image files is created one level below the DCIM directory. In addition, even if the number of still image files recorded one level below 101_PANA does not reach 9999, 102_PANA which is a new image directory for recording still image files can be created one level below the DCIM directory.

Thereafter, likewise, with an increase in the number of still image files, creation of a new image directory for recording still image files is performed.

A PRIVATE directory is a directory for recording files other than still image files.

A MOV_SHOT directory is an intermediate file storage directory for recording intermediate files. An intermediate file is a file that holds information about instructions for shooting still images provided during moving image recording. FIG. 4 shows a state in which only one intermediate file with the file name P1000005.dat is recorded one level below the MOV_SHOT directory.

An intermediate file storage directory and an intermediate file are created by the controller 130 when moving image recording starts. A file name of the intermediate file is determined based on a DCF object number numbered in a still image file for recording the first still image shot during the moving image recording. For example, when moving image recording starts in a state in which the name of the newest file in chronological order among still image files recorded within or below DCIM is P1010002.jpg, a moving image file such as P1010003.mov is created within or below DCIM when moving image recording starts. Thus, an intermediate file name created within or below MOV_SHOT is P1010004.dat. As such, the file names of a still image file, a moving image file, and an intermediate file are provided such that the last four digits (the fifth to eighth characters) of the file names are basically sequential numbers in chronological order.

2-1-1 Intermediate File

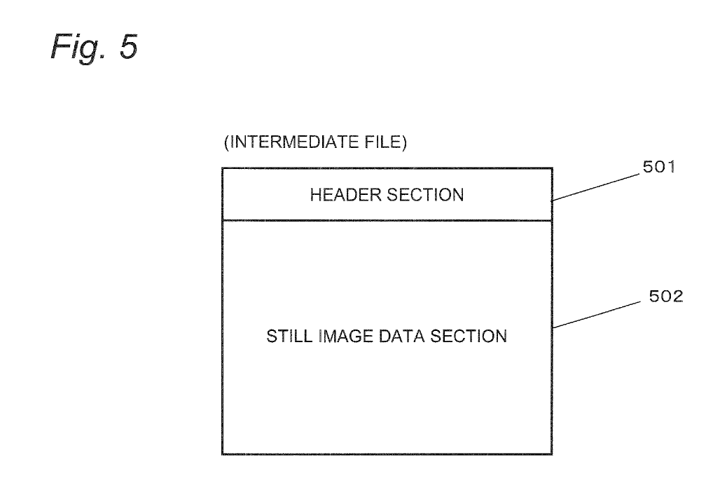

FIG. 5 shows a data structure of an intermediate file. An intermediate file includes a header section 501 and a still image data section 502.

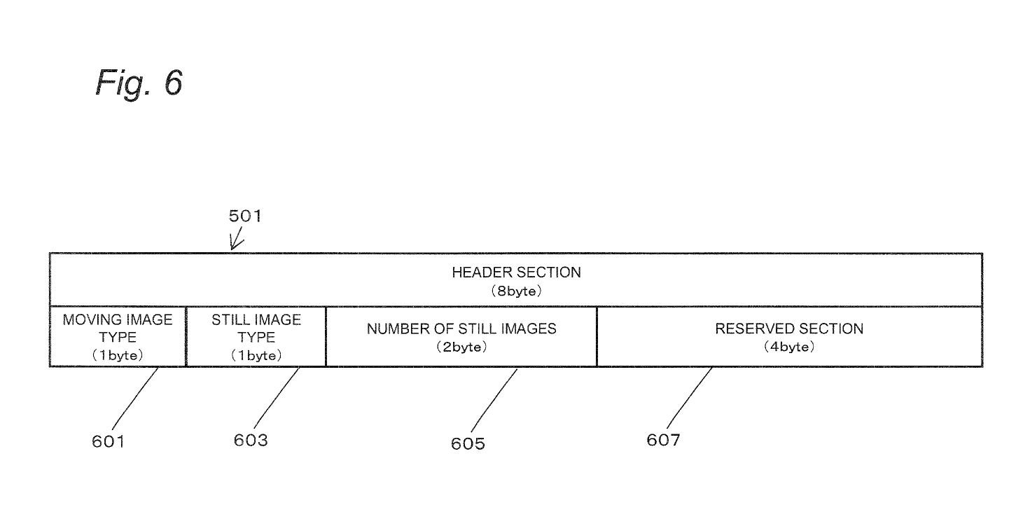

FIG. 6 shows a detailed structure of the header section 501 of the intermediate file. The header section 501 includes a moving image type 601 representing the type of a moving image being recorded; a still image type 603 representing the type of still images to be recorded; the number of still images 605 indicating the number of pieces of still image information recorded in the still image data section 502; and a reserved section 607. The moving image type 601 represents the type of a moving image file recorded when still image files are recorded. The types of a moving image file include, for example, AVCHD and Motion JPEG. The still image type 603 represents the type of still images recorded when pressing the shutter during moving image recording. When the moving image recording ends, still images are recorded in the format of the type represented by the still image type 603. The types of a still image include, for example, JPEG and RAW. The number of still images 605 represents the number of pieces of still image information 701 recorded in the intermediate file, i.e., the number of instructions for still images provided during the moving image recording. The number of still images 605 is added one by one each time the user provides an instruction for shooting a still image during the moving image recording.

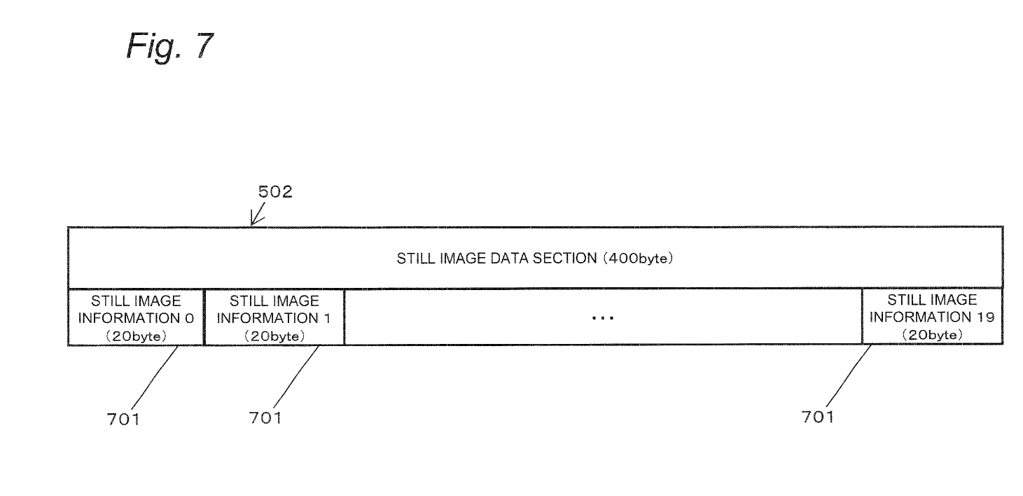

FIG. 7 shows a detail of the still image data section 502 of the intermediate file. The still image data section 502 includes a plurality of pieces of still image information 701. In the still image data section 502, pieces of still image information 701, number of which is indicated by the number of still images 605, is recorded. Each time the user provides an instruction for shooting a still image during the moving image recording, a piece of still image information 701 is added and recorded in the still image data section 502.

In the still image data section 502, still image information 701 is recorded in the following manner. Note that in an example shown in FIG. 7 the still image data section 502 has areas numbered 0 to 19 where 20 pieces of still image information can be recorded. When still image information 701 is recorded in response to an instruction for shooting a still image provided by the user during moving image recording, the number of still images 605 is referred to and still image information about a shot still image is recorded in an area associated with a number indicated by the number of still images 605. For example, when the number of still images 605 is 10, still image information 701 is recorded in an area of No. 10.

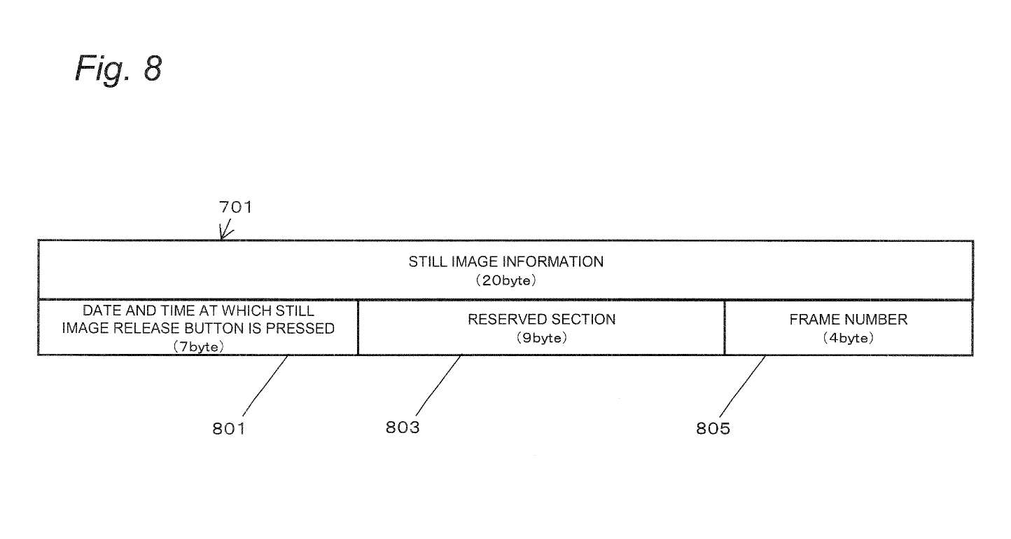

FIG. 8 shows a detail of still image information 701 included in the still image data section 502. The still image information 701 includes date and time 801 at which the still image release button 201 is pressed; a reserved section 803; and a frame number 805 in a moving image which is related to the still image information. The date and time 801 at which the still image release button 201 is pressed during moving image recording is used as, for example, still image shooting date and time information which is used when creating a still image based on the still image information 701. The frame number 805 indicates in which frame a still image, which is a target of still image shooting during the moving image recording, is present from the first frame in the moving image.

2-2 Moving Image/Still Image Recording Operation

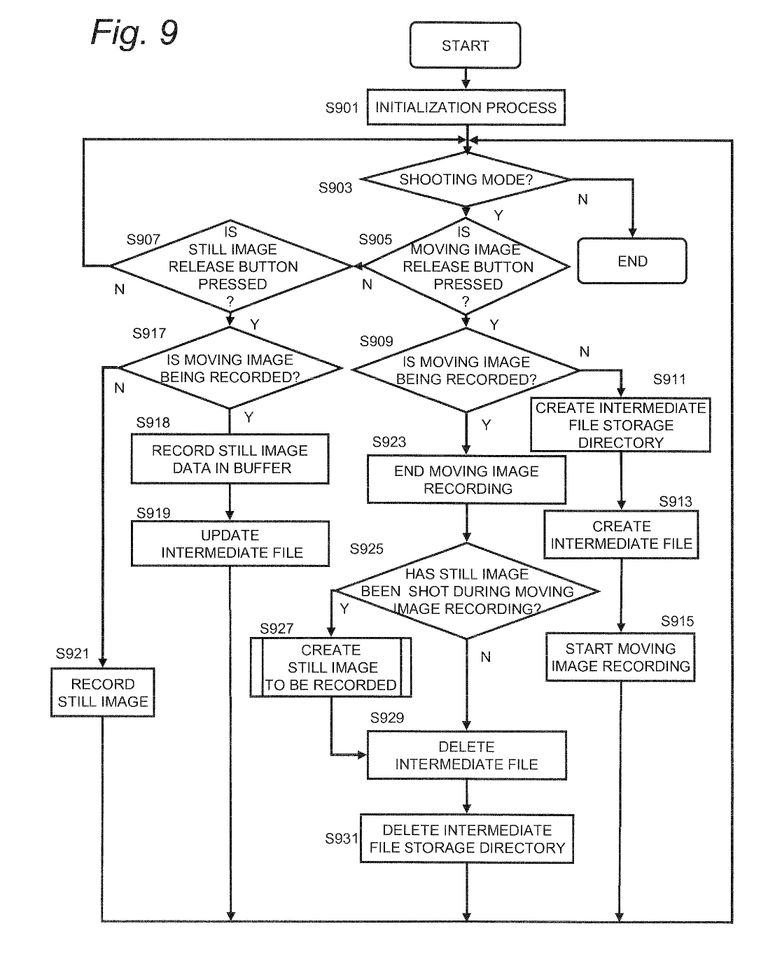

Control of the digital camera 100 performed upon moving images and still images recording will be described. FIG. 9 is a flowchart showing control of the digital camera 100 in shooting mode performed upon moving images and still images recording.

In particular, when the digital camera 100 according to the present embodiment performs still image shooting during moving image recording, the digital camera 100 records still image data in the buffer memory 124 and records, as an intermediate file, information about instructions for shooting still images provided by the user, in a nonvolatile recording medium such as the memory card 140. Then, when the moving image recording ends, by referring to the information about instructions for shooting still images, still image files for still images having received the shooting instructions during the moving image recording are created from the still image data recorded in the buffer memory 124, and are recorded in the recording medium.

In the flowchart in FIG. 9, when the digital camera 100 transitions to shooting mode by an operation of the mode switch 207 by the user, the controller 130 performs an initialization process required for still image/moving image recording (S901).

After the initialization process is completed, the controller 130 repeats a process of checking inputs from the user. The process of checking inputs includes checking of the state of the mode switch 207 (S903), detection of pressing of the moving image release button 206 (S905), and detection of pressing of the still image release button 201 (S907). At this time, if the state of the mode switch 207 is not shooting mode, then the controller 130 ends the shooting mode process.

If the controller 130 detects pressing of the still image release button 201 by the user (YES at S907), then the controller 130 determines whether or not the state of the recording operation of the digital camera 100 is such that a moving image is being recorded (S917).

If the state of the recording operation of the digital camera 100 is not such that a moving image is being recorded (NO at S917), then the controller 130 records still image data generated by the image processor 122 based on image information generated by the CCD image sensor 120, in a recording medium such as the memory card 140 (S921) and returns to step S903. A process for the case in which a moving image is being recorded (YES at S917) will be described later.

Meanwhile, if the controller 130 detects pressing of the moving image release button 206 by the user (YES at S905), then the controller 130 determines whether or not the state of the recording operation of the digital camera 100 is such that a moving image is being recorded (S909). If the state of the recording operation of the digital camera 100 is not such that a moving image is being recorded (NO at S909), then the controller 130 performs creation of an intermediate file storage directory (S911), creation of an intermediate file (S913), and an instruction for starting moving image recording (S915). A series of these processes will be described in detail later.

If the state of the recording operation of the digital camera 100 is such that a moving image is being recorded (YES at S909), then the controller 130 performs an instruction for stopping moving image recording (S923), a determination as to whether or not there has been the instruction for shooting the still image during the moving image recording (S925), creation of still images to be recorded (S927), deletion of the intermediate file (S929), and deletion of the intermediate file storage directory (S931). A detail of the process at step S927 will be described later.

The operation performed when the moving image release button 206 or the still image release button 201 is pressed will be described below for different cases.

(1) The case in which the digital camera 100 is not in the process of recording a moving image when the moving image release button is pressed (YES at step S905 and NO at step S909)

The controller 130 creates the intermediate file storage directory ROOT/PRIVATE/MOV_SHOT in a recording medium such as the memory card 140, according to the directory structure shown in FIG. 4 (S911). Furthermore, the controller 130 records an intermediate file for still image shooting performed during moving image recording which is in the format shown in FIG. 5, in the created intermediate file storage directory (S913). Thereafter, the controller 130 instructs the image processor 122 to start moving image recording (S915). During a period from when the instruction for stating moving image recording is provided from the controller 130 to the image processor 122 until when the controller 130 provides an instruction for stopping moving image recording, pieces of image information generated by the image processor 122 based on image information generated by the CCD image sensor 120 are sequentially recorded, as a moving image, in a recording medium such as the memory card 140.

(2) The case in which the still image release button is pressed during moving image recording (YES at steps S907 and S917)

The controller 130 performs, in parallel with moving image recording operation, a still image recording process including recording of data (RAW data) of a shot still image in the buffer memory 124 (S918) and updating of an intermediate file for still image shooting performed during moving image recording (S919).

Updating of the intermediate file for still image shooting performed during moving image recording is performed in the following manner. The controller 130 records, as still image information 701, date and time 801 at which pressing of the still image release button 201 is detected during moving image recording and a frame number 805 in a moving image obtained at that point in time. Then, the value of the number of still images 605 in the header section 501 of the intermediate file is incremented by one.

(3) The case in which the moving image release button is pressed during moving image recording (YES at steps S905 and S909)

The controller 130 instructs the image processor 122 to stop moving image recording (S923). By this instruction, the image processor 122 terminates generation of image information based on image information generated by the COD image sensor 120, and ends the moving image recording. Then, the controller 130 determines whether or not there has been the instruction for shooting the still image during the moving image recording, by referring to the number of still images 605 in the header section 501 of the intermediate file for still image shooting performed during the moving image recording (S925).

If the value of the number of still images 605 is 0 (NO at S925), then the controller 130 determines that there has been no instruction for shooting the still image during the moving image recording, and thus deletes the intermediate file for still image shooting performed during the moving image recording (S929), and further deletes the intermediate file storage directory ROOT/PRIVATE/MOV_SHOT (S931). After the deletion is completed, the controller 130 returns to step S903.

On the other hand, if the value of the number of still images 605 is not 0 and thus there is still image information 701 in the still image data section 502 (YES at S925), then it is determined that there has been the instruction for shooting the still image during the moving image recording. Thus, the controller 130 creates still images to be recorded, number of which is equal to the number of pieces of still image information 701 (S927). A detail of a process of creating still images to be recorded will be described later. As used herein, a still image to be recorded refers to still image data generated based on still image information 701 and still image data (or moving image frame data) which is stored in the buffer memory 124 so as to be associated with the still image information 701. The created still images to be recorded are recorded in a recording medium such as the memory card 140.

After the creation of still images to be recorded is completed, the controller 130 deletes the intermediate file for still image shooting performed during the moving image recording (S929), and further deletes the intermediate file storage directory ROOT/PRIVATE/MOV_SHOT (S931), and thereafter returns to step S903. As such, when still image shooting during moving image recording ends normally, both an intermediate file storage directory and an intermediate file are deleted. Thus, files not necessary for the user do not remain in a recording medium such as the memory card 140. Accordingly, wasteful use of the capacity of the card does not occur and thus the number of shootable still images is not affected.

2-2-1 Process of Creating Still Images to be Recorded

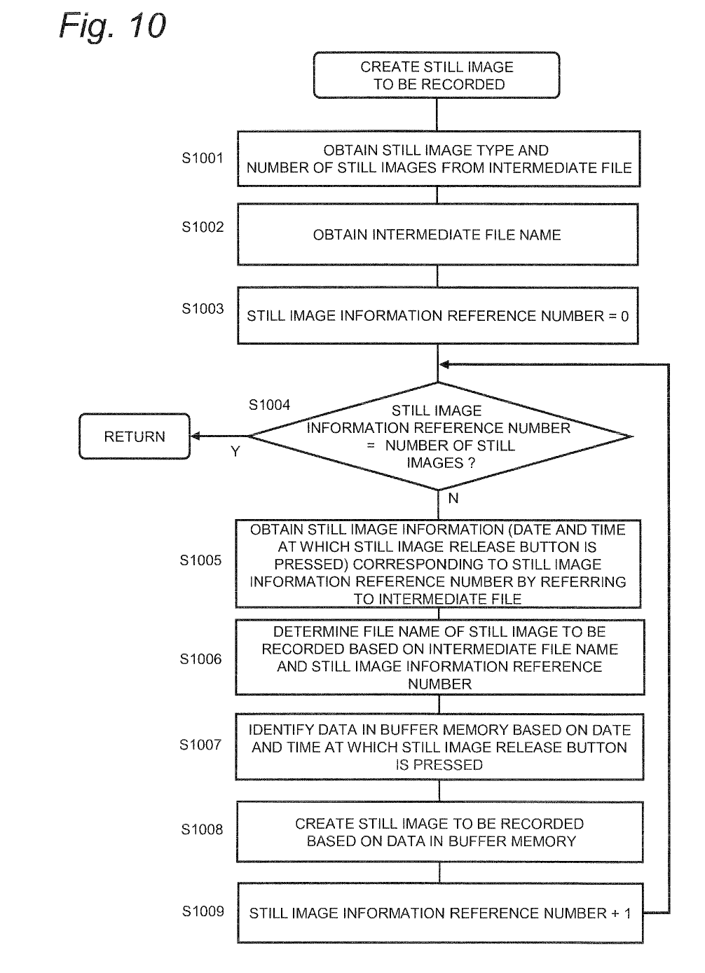

A process of creating still images to be recorded (step S927) will be described in detail using a flowchart in FIG. 10.

Upon creating still images to be recorded, the controller 130 obtains the still image type 603 as information for determining the type of still images to be recorded, and the number of still images 605 from the intermediate file (S1001). In addition, the controller 130 obtains an intermediate file name as file name creation information for determining file names of still images to be recorded (S1002). Then, the controller 130 initializes still image information reference number to 0 (S1003). The still image information reference number is a number for identifying each still image information 701 in the still image data section 502, and is incremented by one each time a still image to be recorded is created. In the following, as shown in FIG. 7, it is assumed that pieces of still image information 701 included in the still image data section 502 are assigned numbers 0, 1, 2, . . . , 19 from the first one.

Then, the controller 130 compares the still image information reference number with the number of still images 605 (S1004). If their values are equal, then it is determined that there is no need to create a still image to be recorded any more and thus the controller 130 ends the process. If their values are not equal, then the controller 130 obtains still image information 701 having a number corresponding to the still image information reference number, from the intermediate file (S1005). The controller 130 determines a file name of a still image to be recorded based on the obtained intermediate file name and the still image information reference number (S1006). Specifically, a file name is determined in the following manner.

A file name of a still image to be recorded is such that the value of the still image information reference number is added to the value of a numerical portion of a DCF object number included in the intermediate file name. For example, when the file name of the intermediate file is P1010004.dat and the still image information reference number is 0, a file name of a still image to be recorded is P1010004.jpg. When the file name of the intermediate file is P1010004.dat and the still image information reference number is 6, a file name of a still image to be recorded is P1010010.jpg. Note that, when the number of still image files recorded one level below an image directory, such as 101_PANA, reaches 9999 during the process of creating still images to be recorded, as with when still images and moving images are individually recorded, a new image directory (for example, 102_PANA) for recording still image files is created one level below DCIM and the process continues.

Returning to FIG. 10, the controller 130 then identifies, based on date and time 801 at which the still image release button 201 is pressed which is obtained at step S1005, data recorded on the date and time indicated by the pressing date and time 801 from among still image data (RAW data) stored in the buffer memory 124 (S1007). Then, the controller 130 creates a still image file in a format indicated by the still image type 603 obtained at step S1001, from the identified still image data (RAW data) (S1008).

After the creation of a still image to be recorded is completed, the still image information reference number is incremented by one (S1009) and the controller 130 returns to step S1004. Thereafter, the above-described processes (S1004 to S1009) are repeated until the still image information reference number is equal to the number of still images 605.

When moving image recording operation ends normally, in the above-described manner, still image files to be recorded are created from still image data recorded in the buffer memory 124 during moving image recording, and are recorded in a recording medium.

2-3 Recovery Operation Performed when the Power Interruption Occurs During Moving Image Recording

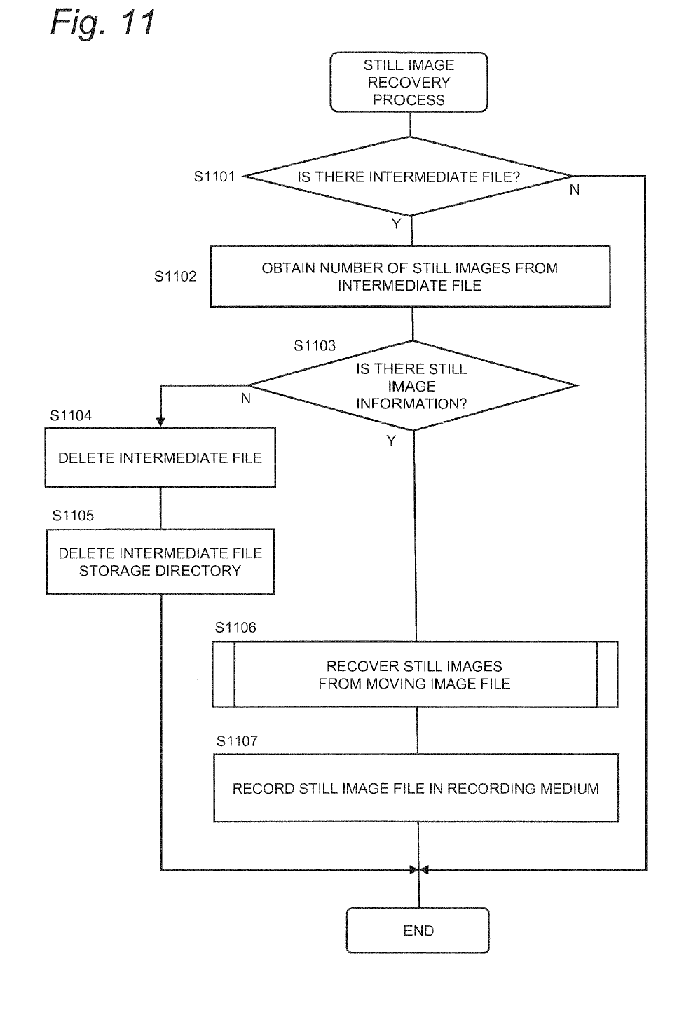

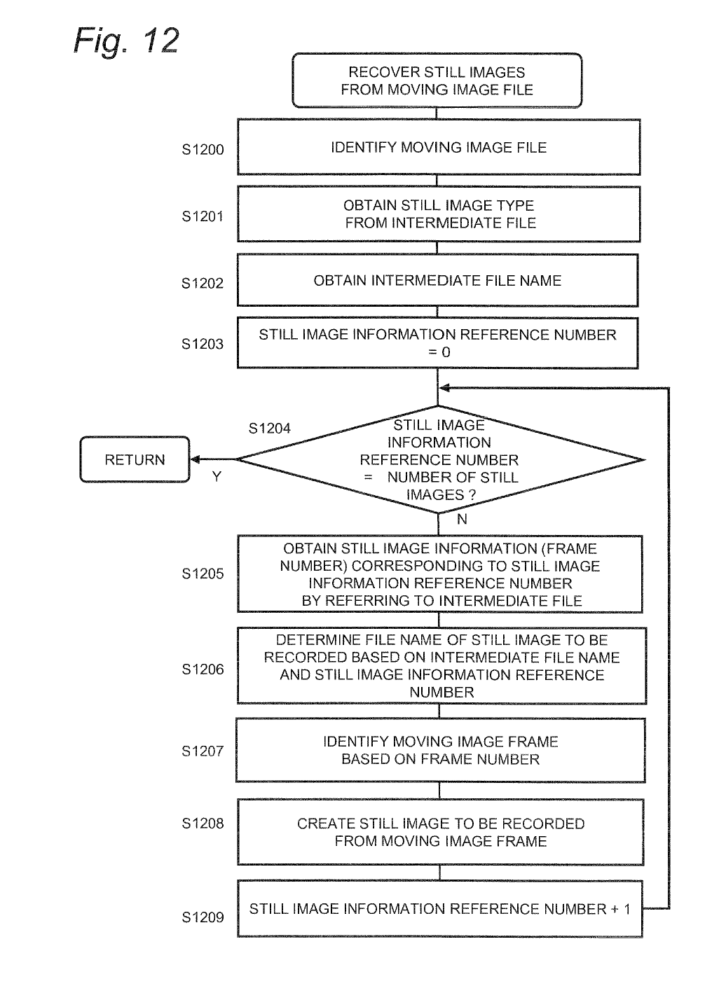

When information on instructions for shooting still images provided during moving image recording is managed in a volatile memory such as the buffer memory 124, if the power interruption suddenly occurs during the moving image recording, then information in the buffer memory 124 disappears, and thus, still images cannot be recovered thereafter. On the other hand, in the present embodiment, information on instructions for shooting still images provided during moving recording is recorded in a nonvolatile recording medium such as the memory card 140, as an intermediate file. By using the intermediate file, even if the power to the digital camera 100 is interrupted during moving image recording, still images shot during the moving image recording can be recovered when the power is restored after the power interruption occurs. The operation of recovering still images for when the power to the digital camera 100 is interrupted during moving image recording will be described below using flowcharts in FIGS. 11 and 12.

Referring to FIG. 11, when the power to the digital camera 100 is turned on after power interruption occurs during moving image recording, the controller 130 checks whether or not there is an intermediate file in a recording medium such as the memory card 140 (S1101). If there is no intermediate file, then it is determined that a recovery process is not necessary and thus a recovery process is not performed. If there is an intermediate file, then the controller 130 obtains the number of still images 605 from a header section 501 of the intermediate file (S1102). The controller 130 determines whether or not there is still image information 701 in a still image data section 502, based on the obtained number of still images 605 (S1103).

If the number of still images 605 is 0 and thus there is no still image information 701 in the still image data section 502, then it can be determined that a recovery process is not necessary. Thus, the controller 130 deletes the intermediate file in the recording medium (S1104) and further deletes the intermediate file storage directory (ROOT/PRIVATE/MOV_SHOT) (S1105).

On the other hand, if the number of still images 605 is not 0 and thus there is still image information 701 in the still image data section 502, then it can be determined that there has been still image shooting during the moving image recording. Thus, the controller 130 recovers still images to be recorded from a moving image file (S1106) and records the recovered still images to be recorded in a recording medium such as the memory card 140 (S1107).

FIG. 12 is a flowchart showing a detail of the process of recovering still images to be recorded from a moving image file (step S1106). In the process of recovering still images to be recorded shown in FIG. 12, a still image file is created from a moving image frame. Hence, first, a moving image file used for recovery is identified (S1200). For example, by referring to the time stamps (recording date and time information, update date and time information and the like) of moving image files recorded in a recording medium such as the memory card 140, a moving image file with the latest time stamp is identified as a moving image file used for recovery, and a file name of the moving image file is obtained. This is done because it is considered that a moving image file is not yet newly recorded immediately after the power is restored from power interruption and a moving image file with the latest time stamp can be estimated as a moving image being recorded when the power interruption occurs. For subsequent processes, the process of recovering still images to be recorded shown in FIG. 12 is substantially the same as the process of creating still images to be recorded shown in FIG. 10, but differs in the following points. Specifically, in the process shown in FIG. 10, data of a still image to be recorded is generated from still image data recorded in the buffer memory 124 based on information on still image release button pressing date and time 801. On the other hand, in the recovery process shown in FIG. 12, in the moving image file identified at step S1200, a moving image frame which is recorded at the time of shooting of a lost still image or at the time close thereto is identified based on information on a frame number 805 (S1207), and data of a still image to be recorded is generated from data of the identified moving image frame (S1208). The processes shown in FIG. 12 other than the above are the same as those shown in FIG. 10.

A file name of the still image to be recorded created at this time is determined based on the file name of the intermediate file and the still image information reference number (i.e., the number for still image information in the still image data section 502). Thus, DCF object numbers of file names for a moving image and still images shot during recording of the moving image are recorded in a sequential manner. In general, a digital camera often plays back still images and moving images in order of DCF object number. Hence, by sequentially recording DCF object numbers of file names for a moving image and still images shot during recording of the moving image, a moving image and still images recorded simultaneously with the moving image can be played back sequentially on such a device.

### 3. Summary

As described above, a digital camera 100 according to the present embodiment is an imaging apparatus capable of recording moving image data and still image data, and includes a CCD image sensor 120 configured to capture a subject image to generate image data; a still image release button 201 configured to receive an instruction for shooting a still image; an image processor 122 configured to record, as moving image data, the image data in a recording medium such as a memory card 140; and a controller 130 configured to record an intermediate file including information about still image shooting, in a nonvolatile recording medium such as the memory card 140, when the still image release button 201 receives an instruction for shooting a still image during the recording of the moving image data.

By such a configuration, even when the power interruption occurs during moving image recording, an intermediate file remains in a recording medium such as the memory card 140. Thus, the user can recover still images for which instructions for shooting still images are provided during the moving image recording, based on information in the intermediate file.

In addition, the controller 130 performs control to record, in the recording medium, file name creation information about a file name of the moving image data together with the information about still image shooting, and record still image data in the recording medium such that the still image data is provided a file name which is created based on the file name creation information so as to have a sequential number assigned to the file name of the moving image data.

By this configuration, a moving image file and still image files shot during recording of the moving image file can be provided file names which reflect the order of recording the files.

### 4. Other Embodiments

An embodiment of the present invention is not limited to that described above and various other embodiments are considered. Other embodiments will be summarized below.

Although the above-described embodiment discloses an example in which an intermediate file storage directory and an intermediate file are deleted from a recording medium when, for example, creation of still images ends, the process is not limited thereto. An intermediate file storage directory and an intermediate file may be left in a recording medium when, for example, creation of still images ends. In the case in which an intermediate file storage directory and an intermediate file are left, the intermediate file in the recording medium may be deleted before a next moving image recording is performed. By this, intermediate files can be prevented from increasing in number in the recording medium with no limit, avoiding the number of still images and moving images to be recorded from being affected.

In the above-described embodiment, a file name of an intermediate file is determined based on a DCF object number numbered in a still image file for recording the first still image shot during moving image recording, and a file name of a still image to be recorded is determined based on the intermediate file name and still image information recorded in the intermediate file. However, a method of determining a file name is not limited thereto as long as still image file names can be created such that a file name of a moving image file and file names of still image files shot during recording of the moving image file include sequential numbers. Specifically, the method can be any as long as file name creation information is recorded in a recording medium, and the file name creation information is used to create a file name of a still image file created when moving image recording ends such that the file name of the still image has a sequential number assigned to a moving image file. In the above-described embodiment, the file name creation information is a DCF object number assigned to a still image file for recording the first still image shot during moving image recording, but may be a number smaller by one than the DCF object number. In addition, although, in the above-described embodiment, the location where file name creation information is recorded is a file name of an intermediate file, file name creation information may be recorded in the intermediate file.

Although, in the above-described embodiment, a frame number is used as information identifying a still image in moving image data upon still image recovery, a still image in moving image data may be identified using other information (for example, a time code) such as the time elapsed from the start of moving image recording.

Although, in the above-described embodiment, a determination as to whether or not still images have been shot during moving image recording is made by referring to the number of still images 605 in a header section 501 of an intermediate file for still image shooting performed during the moving image recording, the configuration may be such that the controller 130 stores information as to whether or not still images have been shot during moving image recording.

Although, in the above-described embodiment, the image processor 122 and the controller 130 are described as having functions and configurations such as those described above respectively, a part of the function and configuration of each of the image processor 122 and the controller 130 may be included in the other.

Although, in the above-described embodiment, in a process of creating still images to be recorded after moving image recording ends (step S927 in FIG. 9), still images to be recorded are created using data recorded in the buffer memory 124, a still image to be recorded may be created from data of a moving image frame recorded upon still image shooting, by referring to data in an intermediate file, as shown in a process in FIG. 12 (steps S1207 and S1208)

Although, in the above-described embodiment, a moving image type 601, a still image type 603, and the number of still images 605 are recorded in a header section 501 of an intermediate file, in addition to these pieces of information, a file name of a moving image file being recorded may be further recorded upon creation of the intermediate file. By referring to the moving image file name recorded in the intermediate file, a moving image file used upon recovery can be easily identified in a recovery process shown in FIG. 12 (step S1200).

### INDUSTRIAL APPLICABILITY

The idea of the present embodiment can be applied to imaging apparatuses having a display unit and equipped with the function of shooting still images during moving image recording, such as digital cameras, movie cameras, and mobile phones.

What is claimed is:

1. An imaging apparatus capable of recording moving image data and still image data, the imaging apparatus comprising:
an imaging unit configured to capture a subject image to generate image data;
an instruction receiving unit configured to receive an instruction for shooting a still image;
a moving image recorder configured to record, as moving image data, the image data in a predetermined recording medium; and
a still image information recorder configured to record information about still image shooting in a nonvolatile recording medium when the instruction receiving unit receives the instruction for shooting the still image during recording of the moving image data.

2. The imaging apparatus according to claim 1, further comprising a still image creating unit configured to generate still image data from the moving image data based on the information about still image shooting recorded in the nonvolatile recording medium.

3. The imaging apparatus according to claim 2, wherein when power is restored after power interruption occurring in a middle of moving image recording by the imaging apparatus, the still image creating unit generates still image data from the moving image data based on the information about still image shooting and records the generated still image data in the predetermined recording medium.

4. The imaging apparatus according to claim 2, wherein when moving image recording ends, the still image creating unit generates still image data from the moving image data based on the information about still image shooting and records the generated still image data in the predetermined recording medium.

5. The imaging apparatus according to claim 1, wherein the information about still image shooting includes information about a date and a time at which the instruction for shooting the still image is provided or about a location of a frame of a moving image being recorded when the instruction for shooting the still image is provided.

6. The imaging apparatus according to claim 1, wherein the information about still image shooting includes information about a number of still images for which shooting instructions are provided during moving image recording.

7. The imaging apparatus according to claim 1, wherein the information about still image shooting includes information about a type of the still image for which a shooting instruction is provided during moving image recording.

8. The imaging apparatus according to claim 1, wherein the information about still image shooting includes information about a type of a moving image being recorded when the instruction for shooting the still image is provided.

9. The imaging apparatus according to claim 1, wherein
the still image information recorder records file name creation information together with the information about still image shooting in the nonvolatile recording medium, the file name creation information which is information based on a file name of the moving image data, and
the still image creating unit creates a file name using the file name creation information and provides the created file name to the generated still image data, the file name created by the still image creating unit having a sequential number assigned to the file name of the moving image data.

10. A method of generating still image data from moving image data recorded in a predetermined recording medium, the method comprising:
obtaining information about shooting of a still image for which a shooting instruction is provided during recording of the moving image data;
identifying a moving image frame in the moving image data based on the obtained information about shooting of the still image; and
generating still image data based on the identified moving image frame.

11. The method of generating still image data according to claim 10, wherein the information about shooting of the still image includes information about a date and a time at which the shooting instruction for the still image is provided or information about a location of a moving image frame being recorded when the shooting instruction for the still image is provided.

12. A non-transitory computer-readable recording medium having a program, the program causing a computer to perform the functions of:
obtaining information about shooting of a still image for which a shooting instruction is provided during recording of moving image data;
identifying a moving image frame in the moving image data based on the obtained information about shooting of the still image; and
generating still image data based on the identified moving image frame.

13. The recording medium according to claim 12, wherein the information about shooting of the still image includes information about a date and a time at which the shooting instruction for the still image is provided or information about a location of the moving image frame being recorded when the shooting instruction for the still image is provided.

14. A method of recovering still image data, the method comprising:
recording information about still image shooting in a nonvolatile recording medium when an instruction for shooting a still image is received during recording of moving image data; and
generating still image data from the moving image data based on the information about still image shooting recorded in the nonvolatile recording medium.
